(19) United States
(12) Patent Application Publication
(10) Pub. No.: US 2026/0184960 A1
(43) Pub. Date: Jul. 2, 2026

(54) INSULATIVE SILICONE COATING COMPOSITION

(71) Applicant: PPG INDUSTRIES OHIO, INC., Cleveland, OH (US)

(72) Inventors: Nicole Lynn Rakers, Delmont, PA (US); Qiang Huang, Pittsburgh, PA (US); Gereme Thomas Hensel, Cranberry Township, PA (US); Adam James Kolcun, Sewickley, PA (US); Dikran Betzig, Bolton, MA (US)

(73) Assignee: PPG INDUSTRIES OHIO, INC., Cleveland, OH (US)

(21) Appl. No.: 18/857,931

(22) PCT Filed: May 8, 2024
(86) PCT No.: PCT/US2024/028235

§ 371 Date: Oct. 18, 2024

Related U.S. Application Data
(60) Provisional application No. 63/501,806, filed on May 12, 2023.

(51) Int. Cl. C09D 183/04; C08K 5/5419; C08K 5/5435; C09D 7/48; C09D 7/61; C09D 7/63; C09D 7/65

(52) U.S. Cl. CPC C09D 183/04; C08K 5/5419; C08K 5/5435; C09D 7/48; C09D 7/61; C09D 7/63; C09D 7/65

(57) ABSTRACT

Disclosed herein is an insulative coating composition comprising: (a) a room temperature vulcanizing (RTV) polymer, wherein the RTV polymer comprises (i) a polysiloxane including hydroxy, acetoxy, epoxy, alkoxy, oxime, and/or amine terminal groups, and/or (ii) a set of reaction components that react to form the polysiloxane including hydroxy, acetoxy, epoxy, alkoxy, oxime, and/or amine terminal groups; (b) an adhesion promoter comprising a silane that includes an alkoxy functional group and an epoxide functional group; (c) an insulating agent; and (d) a carrier.

### CROSS-REFERENCE TO RELATED APPLICATIONS

This application claims priority to and the benefit of U.S. Provisional Patent Application No. 63/501,806, filed May 12, 2023, which is incorporated herein by reference in its entirety.

### FIELD

This disclosure relates to insulative silicone coating compositions, coatings formed therefrom, and methods of using such coatings.

### BACKGROUND

Coatings used to insulate components such as metallic pipes typically use aqueous acrylic emulsions or epoxy binders. Such coatings are associated with limitations such as the requirement for multiple coats to achieve a desired film thickness, the requirement of a primer for corrosion control, and the requirement of a sealer coat and/or jacket for moisture permeability and UV protection. Moreover, under thermal loads above temperatures above 300° F. (150° C.), such systems typically degrade in approximately 5-7 years.

### SUMMARY

Disclosed herein is an insulative coating composition comprising: (a) a room temperature vulcanizing (RTV) polymer, wherein the RTV polymer comprises (i) a polysiloxane including hydroxy, acetoxy, epoxy, alkoxy, oxime, and/or amine terminal groups, and/or (ii) a set of reaction components that react to form the polysiloxane including hydroxy, acetoxy, epoxy, alkoxy, oxime, and/or amine terminal groups; (b) an adhesion promoter comprising a silane that includes (i) a polymer crosslinking group, such as an acetoxy, alkoxy, oxime, or amine group, and (ii) a substrate adhesion group, such as an epoxide, hydroxy, isocyanate, mercapto, phosphonate, or ester group; (c) an insulating agent; and (d) a carrier.

Also disclosed herein is a method for coating a substrate by applying the disclosed coating composition to at least a portion of the substrate. Also disclosed herein is a substrate coated at least in part with the disclosed coating composition.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

FIG. 1 is a graph showing results of a pull-off adhesion test comparing the disclosed insulative coating composition to comparative coating compositions.

FIG. 2 is a graph showing results of a thermal conductivity test comparing the disclosed insulative coating composition to comparative coating compositions.

FIG. 3 is a graph showing results of a coating skin temperature test comparing the disclosed insulative coating composition to comparative coating compositions.

### DETAILED DESCRIPTION

### Coating Composition Overview

Disclosed herein is an insulative coating composition comprising: (a) a room temperature vulcanizing (RTV) polymer, wherein the RTV polymer comprises (i) a polysiloxane including hydroxy, acetoxy, epoxy, alkoxy, oxime, and/or amine terminal groups, and/or (ii) a set of reaction components that react to form the polysiloxane including hydroxy, acetoxy, epoxy, alkoxy, oxime, and/or amine terminal groups; (b) an adhesion promoter comprising a silane that includes (i) a polymer crosslinking group, such as an acetoxy, alkoxy, oxime, or amine group, and (ii) a substrate adhesion group, such as an epoxide, hydroxy, isocyanate, mercapto, phosphonate, or ester group; (c) an insulating agent; and (d) a carrier. Also disclosed herein is a method for coating a substrate by applying the disclosed coating composition to at least a portion of the substrate. Also disclosed herein is a substrate coated at least in part with the disclosed coating composition.

The insulative coating composition described herein can enable effective adhesion to a substrate to which it is applied, effective thermal insulation, and/or effective corrosion protection, for example. The disclosed insulative coating composition may be applied to a substrate with a suitable film thickness (e.g., 100 mils to 1000 mils, commonly up to 500 mils) by way of single or multiple applied coats. The insulative coating composition can be a sprayable composition. The term “sprayable” means that the coating composition can be applied to a substrate using conventional spray equipment (e.g., texture air sprayer or high volume, low pressure (HVLP) air sprayer) for coating compositions.

The insulative coating composition can comprise a two part system. For example, the RTV polymer and the adhesion promoter can be included in a first part of the two part system, and a catalyst is included in a second part of the two part system.

### RTV Polymer

An RTV polymer refers to a curable polysiloxane that is curable at room temperature (e.g., 20° C. to 25° C.) in the presence of moisture and/or catalyst. The RTV polymer can be cured at room temperature or other suitable temperatures, such as within a range of 5° C. to 38° C.

The RTV polymer can be a polysiloxane including hydroxy, acetoxy, alkoxy, oxime, and/or amine terminal groups. A suitable RTV polymer can have Formula (I):

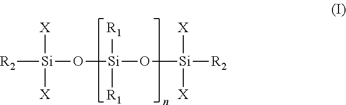

In Formula I, each R₁ can independently be H or alkyl (e.g., C1 to C6 alkyl), such as where each R₁ is methyl such that the polysiloxane of Formula I is a dimethyl polysiloxane. Each R₂ can be H or alkyl (e.g., C1 to C6 alkyl). Each X terminal group can independently be hydroxy, acetoxy, epoxy, alkoxy, oxime, or amine. The X terminal groups can be the same or different.

In Formula I, n can be selected such that the RTV polymer has an average molecular weight of 10,000 to 150,000, such as 50,000 to 140,000, or 75,000 to 130,000, or 100,000 to 125,000, or a range with endpoints selected from any combination of the foregoing values. All molecular weights (Mw) disclosed herein can be determined by gel permeation chromatography using a polystyrene standard for calibration. Suitable RTV polymers include commercially available RTV polymers such as ELASTOSIL E951 and ELASTOSIL M4444 (Wacker Chemical Corporation, Adrian, MI).

The RTV polymer can be further cured and/or crosslinked using water that is available in the ambient atmosphere and/or within the coating composition. Water hydrolyzes the hydrolysable terminal groups on the polysiloxane, resulting in free hydroxy groups available for condensation reactions that further cure and/or crosslink the RTV polymer.

The RTV polymer can be formed from a multi-part system comprising a binder portion and a crosslinking portion. For example, the RTV polymer can be formed from a set of components comprising a hydroxy terminated polysiloxane (e.g., a hydroxy terminated dimethyl polysiloxane) and a functional silane (e.g., a silane including a hydrolysable group such as an acetoxy, epoxy, alkoxy, oxime, or amine). For example, the RTV polymer can be formed from a set of reaction components comprising the hydroxy terminated polysiloxane of Formula II and the functional silane of Formula III:

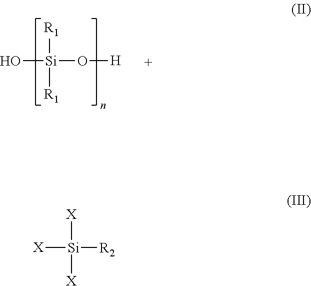

In Formula II, each R₁ can independently be H or alkyl (e.g., C1 to C6 alkyl). In Formula III, each X can independently be acetoxy, epoxy, alkoxy, oxime, or amine, and R₂ can be H or alkyl (e.g., C1 to C6 alkyl). The X terminal groups can be the same or different. In Formula II, n may be selected to provide a polysiloxane of desired molecular weight.

The set of components from which the RTV polymer is formed can further include fillers such as silica (i.e., SiO₂), silanes, and/or silylamines (e.g., trialkylsilylamines such as bis(trimethylsilyl)amine).

The insulative coating composition can include an RTV polymer, such as shown in Formula I, and/or a set of reaction components for forming an RTV polymer, such as shown in Formulas II and III. As used herein, the term RTV polymer can refer to a functionalized polysiloxane such as in Formula I or to a set of reaction components such as shown in Formulas II and III.

The RTV polymer can be included at a concentration of up to 50 wt. %, up to 40 wt. %, or up to 30 wt. %, such as 3 wt. % to 25 wt. %, 4 wt. % to 20 wt. %, 5 wt. % to 15 wt. or 5 wt. % to 10 wt. %, or a range with endpoints selected from any combination of the foregoing values, based on total weight of the coating composition.

The insulative coating composition can be essentially free or completely free of polysiloxane resins apart from the RTV polymer. For example, the insulative coating composition can be free of alkoxy functional polysiloxane resins (such as methoxy functional polysiloxane resins) that are different from the RTV polymer.

### Adhesion Promoter

The adhesion promoter can comprise a silane that includes a polymer crosslinking group and a substrate adhesion group. The polymer crosslinking group can include an alkoxy, acetoxy, oxime, or amine group. The substrate adhesion group can include an epoxide (i.e., epoxy group or oxiranyl group), hydroxy, isocyanate (i.e., —N═C=O), mercapto (i.e., —SH), phosphonate, or ester group. The epoxide group can include a glycidoxy group, such as a glycidoxyalkyl group, such as a glycidoxypropyl group.

As used herein, an epoxide group refers to a group with the formula

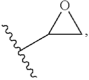 [SMILES: *C1CO1]

a glycidyl group refers to a group with the formula

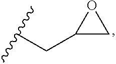 [SMILES: *CC1CO1]

and a glycidoxy group refers to a group with the formula

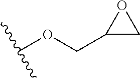 [SMILES: *OCC1CO1]

The adhesion promoter can include multiple (e.g., two or three) crosslinking groups, such as multiple (e.g., two or three) alkoxy groups. The alkoxy groups can independently be C1 to C6 alkoxy groups (e.g., methoxy, ethoxy, et cetera).

The adhesion promoter can include (3-glycidoxypropyl) trimethoxysilane, such as shown in Formula IV:

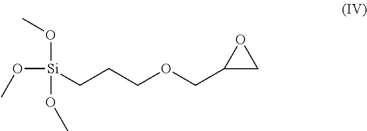

Suitable adhesion promoters include the silane product commercially available under the name GENIOSIL GPTM (Wacker Chemical Corporation, Adrian, MI).

The adhesion promoter can be included at a concentration of 0.5 wt. % to 8 wt. %, such as 1 wt. % to 4 wt. %, or a range using any combination of the foregoing values as endpoints, based on total weight of the coating composition.

### Moisture Scavenger

The coating composition can include a moisture scavenger. The moisture scavenger can include (i) a vinyl group and/or phenyl group, and (ii) an alkoxy group (e.g., a C1 to C6 alkoxy group such as methoxy, ethoxy, et cetera). For example, the moisture scavenger can include vinyl trimethoxysilane and/or phenyl trimethoxysilane. Suitable moisture scavengers include the silane product commercially available under the name GENIOSIL XL-10 (Wacker Chemical Corporation, Adrian, MI).

Such a moisture scavenger can be included at a concentration of 0.5 wt. % to 8 wt. %, such as 1 wt. % to 4 wt. %, or a range using any combination of the foregoing values as endpoints, based on total weight of the coating composition.

### Catalyst

The insulative coating composition can also include a catalyst. The catalyst can include a tin-based and/or titanate-based catalyst. The titanate catalyst can include an alkoxy titanate, such as tert-n-butyl titanate such as commercially available under the name TYZOR TNBT (Dorf Ketal, Houston, TX). The tin-based catalyst can include (i) an alkyl group, such as a C1 to C6 alkyl, such as butyl, and/or (ii) an acetoxy group. For example, the tin-based catalyst can include dibutyltin diacetate such as commercially available under the name FASCAT 4200 (PMC Organometallix, Carrollton, KY).

The total amount of catalyst can be included at a concentration of 0.5 wt. % to 5 wt. %, such as 0.75 wt. % to 3 wt. %, or 1 wt. % to 2.5 wt. %, or a range using any combination of the foregoing values as endpoints, based on total weight of the coating composition.

When the coating composition comprises a two part system, the RTV polymer and/or the adhesion promoter can be included in a first part (i.e., part A) of the two part system while the catalyst is included in a second part (i.e., part B) of the two part system.

### Insulating Agent

The term “insulating agent” refers to a component that enhances the thermal insulating property of a coating when applied to a substrate. For example, the coating composition when applied to a heated metal substrate, such as a metal pipe through which fluid flows at elevated temperature, provides insulation from the heated metal substrate.

The insulating agent can include microspheres, such as hollow microspheres comprising glass, borosilicate, aluminum silicate, ceramic, and/or polymer material. Hollow microspheres can exhibit insulative properties by virtue of the air or gas volume contained therein. Suitable microspheres include the microsphere product commercially available under the name Q-CEL 7040S (Potters Industries, Malvern, PA).

Certain insulating agents (e.g., microspheres) may also function as passivation agents. Suitable insulating agents that also function as passivation agents include sodium silicate. The term passivation refers to the ability to exhibit corrosion resistance such as by forming a nonreactive or passive portion on a substrate. Where insulating agents are used that do not function as passivating agents, auxiliary passivating agents such as magnesium oxide, zinc phosphate, metal-modified zinc phosphates, metal-modified phosphosilicate and/or metal-modified borosilicate, wherein the metal comprises calcium, barium, strontium, molybdenum, magnesium and/or aluminum, may be included.

The coating composition can also include mineral fibers. Suitable mineral fibers include those sold under the trade name LAPINUS MS603 (Lapinus Fibres BV, Roermond, NL).

The insulating agent can be included at a concentration of 5 wt. % to 40 wt. %, such as 7.5 wt. % to 25 wt. %, or 10 wt. % to 20 wt. %, or a range using any combination of the foregoing values as endpoints, based on total weight of the coating composition.

### Carrier

The RTV polymer, adhesion promoter, and/or other resin components of the coating composition can be dissolved in the carrier or can be suspended in the carrier. For example, the coating composition can be a solution wherein the RTV polymer (and/or other resin components) is dissolved or can be a dispersion wherein the RTV polymer (and/or other resin components) is suspended.

The carrier can include a solvent such as a ketone (e.g., acetone), alcohol, aliphatic hydrocarbon, aromatic hydrocarbon, ester, ether, and/or halogenated hydrocarbon. Suitable solvents include, for example, acetone, methyl ethyl ketone (i.e., butanone), methyl amyl ketone (i.e., 2-heptanone), xylene, toluene, mineral spirits, methyl acetate, cyclohexane, dimethyl carbonate, parachlorobenzotrifluoride, and combinations thereof. The carrier can include water.

The carrier can be included at 40 wt. % to 80 wt. %, such as 50 wt. % to 70 wt. %, or a range using any combination of the foregoing values as endpoints, based on total weight of the coating composition.

### Other Coating Composition Components

The insulative coating composition can include other components such as fillers, rheological modifiers (e.g., bentonite clay derivatives), coalescent agents, dispersants, defoamers, pH regulators, matting agents, biocides, fungicides, moisture scavengers (e.g., an alkoxysilane such as a phenyl trialkoxysilane such as phenyl trimethoxysilane), pigments, aggregates, plasticizers, additional adhesion promoters, suspending agents, thixotropic agents, fillers (e.g., mineral wool, Wollastonite, stone wool insulation, graphite, alumina, potassium titanate), catalyst chelators, pigment wetting agents, bituminous and asphaltic extenders, antisettling agents, diluents, UV light stabilizers, air release agents, surfactants, other coating composition components known in the art, or combinations thereof.

The insulative coating composition may comprise up to 10 wt. % of such components based on the total weight of the coating composition.

### Example Functional Properties

The insulative coating composition, when cured, can beneficially exhibit effective adhesion and insulative functions. For example, the disclosed insulative coating composition, when cured, can exhibit a pull-off adhesion strength of 50 psi or greater (e.g., 100 psi, 150 psi, 200 psi, 250 psi, 300 psi, 350 psi, 400 psi, or a range using any of the foregoing as endpoints), after room temperature cure, according to ASTM D4541-22, and/or a pull-off adhesion strength of 50 psi or greater (e.g., 100 psi, 150 psi, 200 psi, 250 psi, 300 psi, 350 psi, 400 psi, or a range using any of the foregoing as endpoints), after 260° C. exposure for 100 hours, according to ASTM D4541-22.

The disclosed insulative coating composition, when cured, can exhibit a thermal conductivity of 0.12 W/m*K or less (e.g., down to 0.10 W/m*K) according to ASTM 7984-16 measured at 50° C.

The disclosed insulative coating composition, when applied to a substrate (e.g., metallic pipe) and cured thereon, can exhibit corrosion protection better than or substantially similar to that from an insulation system that includes (i) spray on insulation primer, (ii) mechanical insulation, and (iii) jacketing. Such conventional insulation systems typically involve an initial layer of primer layer, followed by application of mechanical insulation to a desired thickness, followed by application of a sealer coat and/or jacket (usually metal) to protect the insulation from moisture, UV light, and other external factors. The disclosed insulative coating compositions can beneficially perform as well or better than such conventional insulation systems without requiring the same complexity in number of components and application steps.

### Example Methods of Use

The disclosed insulative coating composition may be applied to a substrate with a suitable film thickness (e.g., 100 mils to 1000 mils, commonly up to 500 mils) by a single or multiple coatings. The insulative coating composition can be a sprayable composition. The term “sprayable” means that the coating composition can be applied to a substrate using conventional spray equipment for coating compositions.

The substrate may include, for example, metals and/or other materials that may be subject to degradation from blistering, cracking, failed adhesion, and/or corrosion. Metal substrates suitable for use with the disclosed coating composition include ferrous and non-ferrous metals such as tin, aluminum, steel (e.g., stainless steel, tin-plated steel, chromium passivated steel, galvanized steel, coiled steel), other coiled metal, zinc, aluminum, nickel, copper, magnesium, silver, gold, other metals, and alloys and mixtures thereof.

Such substrates may form at least a portion of a component of industrial equipment. Nonlimiting examples include reactors, exhaust stacks, reformers, distillation columns, piping, valves, heat exchangers, boilers, and/or vessels (e.g., storage tanks for materials such as industrial liquids, hydrocarbon fuels and liquid natural gas). Such equipment may be utilized in various industries, such as food processing, pulp and paper production, and agricultural-related power generation.

Other substrates to which the disclosed coating composition may be applied includes glass; fiberglass; carbon fiber composites; basalt fiber composites; siloxane and ceramic fibers; ceramics, such as, silicon nitride, silicon carbide, silica, alumina, zirconia, and the like; plastics such as polymethyl methacrylate, polyurethane, polycarbonate, polyesters including polyethylene terephthalate, polyimides, polyamides, epoxy resins, ABS polymer, polyethylene, polypropylene, polyoxymethylene; porous mineral materials such as concrete, clay bricks, marble, basalt, asphalt, loam, terracotta; organic materials such as wood, leather, parchment, paper and textiles; and coated surfaces, such as, plastics emulsion paints, acrylic coatings, epoxy coatings, melamine resins, polyurethane resins and alkyd coatings. The substrate may comprise multiple layers of materials and/or multiple surfaces formed of different materials.

### Additional Terms & Definitions

As used herein, the term “polymer” refers broadly to prepolymers, oligomers and both homopolymers and copolymers. The term “resin” is used interchangeably with “polymer.”

Although particular examples of coating compositions are described herein, the examples do not limit the scope of the present disclosure. For example, where specific ethylenically unsaturated monomers are described by way of example, it will be understood that other ethylenically unsaturated monomers may additionally or alternatively be used.

Plural use of terms encompasses singular use of the terms and vice versa. For example, while the disclosed coating composition has been described in terms of including “an” insulating agent and “a” RTV polymer, additional insulating agents and/or RTV polymers may be included.

Any numerical range recited herein is intended to include all subranges subsumed therein. When ranges are given, any endpoints of those ranges and/or numbers within those ranges can be combined within the scope of the present disclosure.

Unless otherwise indicated, numbers expressing quantities, proportions, percentages, or other measurements used in the specification and claims are to be understood as being modified by the term “about” or its synonyms, even if the term does not expressly appear. Optionally, numbers may be modified by the express use of the term “exactly” to clarify specific instances where the term “about” does not apply.

When the term “about” or its synonyms (e.g., “approximately,” “substantially,” “essentially,” etc.) are used in conjunction with a stated amount, value, or condition, it may be taken to mean an amount, value, or condition that deviates by 10% or less, 5% or less, 1% or less, 0.1% or less, or 0.01% or less from the stated amount, value, or condition. For example, a concentration of “about” X wt. % includes values that differ from X (higher or lower) by up to 10%, up to 5%, up to 1%, up to 0.1%, or up to 0.01%. For example, a concentration of “about” 50 wt. % is synonymous with a range of 45 wt. % to 55 wt. %, or 47.5 wt. % to 52.5 wt. %, or 49.5 wt. % to 50.5 wt. %, etcetera.

“Including” and like terms mean “including but not limited to”. Similarly, as used herein, the terms “on”, “applied on/over”, “formed on/over”, “deposited on/over”, “overlay” and “provided on/over” a surface mean applied, formed, deposited, overlay, or provided, respectively, on but not necessarily in contact with the surface. For example, a coating layer “formed over” a substrate does not preclude the presence of one or more other coating layers of the same or different composition located between the formed coating layer and the substrate.

The insulative silicone coating composition disclosed herein should be understood as comprising/including one or more of the disclosed components, and may therefore include additional components not specifically described. Alternatively, the insulative silicone coating composition can be recited as “consisting essentially of” or “consisting of” one or more of the disclosed components. As used herein, a coating composition “consisting essentially of” a set of recited components means the coating composition may further include non-recited components so long as such non-recited components do not substantially affect the functional properties (e.g., the adhesion and insulative functions) of the coating composition.

Any of the individual components of the insulative silicone coating composition expressly disclosed herein may optionally be omitted. Moreover, the coating composition disclosed herein is, optionally, essentially free or completely free of components that are not specifically described. That is, non-disclosed components may optionally be essentially omitted or completely omitted from the disclosed insulative silicone coating composition. For example, a particular silane additive or polysiloxane component that is not specifically described as being included in the disclosed insulative silicone coating composition may be optionally excluded (i.e., essentially omitted or completely omitted).

A composition that “essentially omits” or is “essentially free of” a component may include trace amounts and/or non-functional amounts of the component. For example, an “essentially omitted” component may be included in an amount no more than 2.5%, no more than 2%, no more than 1.5%, no more than 1%, no more than 0.1%, or no more than 0.01% by total weight of the composition or by total weight of monomers of the composition.

A composition that “completely omits” or is “completely free of” a component does not include a detectable amount of the component (i.e., does not include an amount above any inherent background signal associated with the testing instrument) when analyzed using standard coating composition analysis techniques such as, for example, chromatographic techniques (e.g., thin-layer chromatography (TLC), gas chromatography (GC), liquid chromatography (LC)), or spectroscopy techniques (e.g., Fourier transform infrared (FTIR) spectroscopy).

Any headings and subheadings used herein are for organizational purposes only and are not meant to be used to limit the scope of the description or the claims.

### EXAMPLES

### Example 1

A two part coating composition (comprising part A and part B) was prepared according to the components listed in Table 1.

TABLE 1

| | | |
|---|---|---|
| Material | Function | Weight (g) |

Part A

| | | |
|---|---|---|
| Methyl ethyl ketone | Carrier | 25.35 |
| Methyl amyl ketone | Carrier | 25.35 |
| RTV silicone polymer * | Binder | 15.89 |
| Vinyl trimethoxysilane | Moisture Scavenger | 3.70 |
| Mineral fiber | Insulating agent | 7.67 |
| Hollow microspheres | Insulating agent | 20.50 |
| Other components** | | to 100 g total |

Part B

| | | |
|---|---|---|
| Methyl ethyl ketone | Carrier | 41.03 |
| Methyl amyl ketone | Carrier | 41.03 |
| Water | Carrier | 8.86 |
| Dibutyltin diacetate | Catalyst | 1.37 |
| Tetra-n-butyl titanate | Catalyst | 1.37 |
| Other components* | | to 100 g total |

* RTV Silicone System based on a hydroxy functional polysiloxane and an acetoxy functional silane, available commercially as ELASTOSIL E951.
**Other coating composition components disclosed herein and customary in the art.
*Other coating composition components disclosed herein and customary in the art.

### Example 2

A two part coating composition (comprising part A and part B) was prepared according to the components listed in Table 2.

TABLE 2

| | | |
|---|---|---|
| Material | Function | Weight (g) |

Part A

| | | |
|---|---|---|
| Methyl ethyl ketone | Carrier | 25.35 |
| Methyl amyl ketone | Carrier | 25.35 |
| RTV silicone polymer* | Binder | 11.81 |
| (3-glycidoxypropyl)trimethoxysilane | Adhesion promoter | 4.08 |
| Vinyl trimethoxysilane | Moisture scavenger | 3.70 |
| Mineral fiber | Insulating agent | 7.67 |
| Hollow microspheres | Insulating agent | 20.50 |
| Other components** | | to 100 g total |

Part B

| | | |
|---|---|---|
| Methyl ethyl ketone | Carrier | 41.03 |
| Methyl amyl ketone | Carrier | 41.03 |
| Water | Carrier | 8.86 |
| Dibutyltin diacetate | Catalyst | 1.37 |
| Tetra-n-butyl titanate | Catalyst | 1.37 |
| Other components* | | to 100 g total |

*RTV Silicone System based on a hydroxy functional polysiloxane and an acetoxy functional silane, available commercially as ELASTOSIL E951.
**Other coating composition components disclosed herein and customary in the art.
*Other coating composition components disclosed herein and customary in the art.

The coating composition of Example 2 was therefore similar to the coating composition of Example 1 except for the inclusion in part A of an adhesion promoter comprising both alkoxy and epoxide functionalities and a slight reduction in the amount of RTV silicone polymer.

### Example 3

A two part coating composition (comprising part A and part B) was prepared according to the components listed in Table 3.

TABLE 3

| | | |
|---|---|---|
| Material | Function | Weight (g) |

Part A

| | | |
|---|---|---|
| Methyl ethyl ketone | Carrier | 25.35 |
| Methyl amyl ketone | Carrier | 25.35 |
| RTV silicone polymer* | Binder | 11.81 |
| Alkoxy polysiloxane resin** | Binder | 4.08 |
| Vinyl trimethoxysilane | Moisture Scavenger | 3.70 |
| Mineral fiber | Insulating agent | 7.67 |
| Hollow microspheres | Insulating agent | 20.50 |
| Other components*** | | to 100 g total |

Part B

| | | |
|---|---|---|
| Methyl ethyl ketone | Carrier | 41.03 |
| Methyl amyl ketone | Carrier | 41.03 |
| Water | Carrier | 8.86 |
| Dibutyltin diacetate | Catalyst | 1.37 |
| Tetra-n-butyl titanate | Catalyst | 1.37 |
| Other components* | | to 100 g total |

*RTV Silicone System based on a hydroxy functional polysiloxane and acetoxy functional silane, available commercially as ELASTOSIL E951.
**Methoxy functional polysiloxane, sold under the trade name DOWSIL 2405 (Dow Chemical Company, Midland, MI).
***Other coating composition components disclosed herein and customary in the art.
*Other coating composition components disclosed herein and customary in the art.

The coating composition of Example 3 was therefore similar to the coating composition of Example 1 except for the inclusion in part A of an additional alkoxy polysiloxane resin and a slight reduction in the amount of RTV silicone polymer. The coating composition of Example 3 was also similar to the coating composition of Example 2 except that the composition of Example 3 replaced the adhesion promoter comprising both alkoxy and epoxide functionalities with the additional alkoxy polysiloxane resin.

### Adhesion Testing

Each of the coating compositions of Examples 1-3 were applied to 100 mm×150 mm×3.175 mm thick steel panels (blasted, 75-100 micron profile, degreased) at a dry film thickness of 5 mm via drawdown. The coated panels were allowed to dry at ambient conditions for 7 days. Pull-off adhesion of the coating from metal substrate was measured according to ASTM D4541-22 by using a pull-off adhesion tester (DeFelsko PosiTest AT-M) with 20 mm dolly. Subsequently, the tested panels were exposed to 260° C. temperatures on a hot plate for 100 hours. Where required, observations were made of cracking, delamination, or blistering on heating. Pull-off adhesion of the heat exposed coating was measured again according to ASTM D4541 with the same tester.

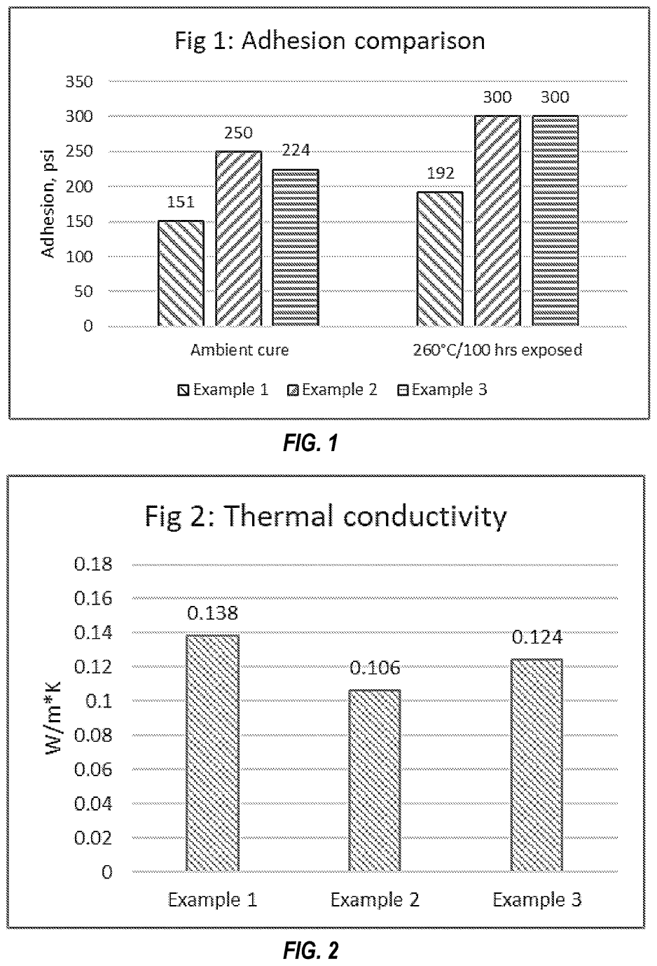

Results of the adhesion testing are shown in FIG. 1. As shown, the coating composition of Example 2 exhibited the best performance. The coating composition of Example 2 exhibited the highest adhesion at ambient cure and exhibited the highest adhesion, along with the coating composition of Example 3, following heat exposure. Results of the adhesion testing are also shown in Table 4.

TABLE 4
Pull-off Adhesion Results (psi)

| Coating | Ambient | | 260° C./100 | |
|---|---|---|---|---|
| Composition | cure | Failure | hrs. exposed | Failure |
| Example 1 | 151 | Adhesive | 192 | Cohesive |
| Example 2 | 250 | Cohesive | 300 | Cohesive |
| Example 3 | 224 | Cohesive | 300 | Cohesive |

### Thermal Conductivity Testing

Each of the coating compositions of Examples 1-3 were prepared by drying wet materials in aluminum dishes under ambient conditions for 7 days. Samples of size 70 mm×70 mm×10 mm were cut and smoothed with 200 grid sandpaper from the dried samples. Thermal conductivities of these samples were measured according to ASTM 7984-16 with a Modified Transient Plane Source (MTPS) Trident C-Therm instrument at 50° C.

Results of the thermal conductivity testing are shown in FIG. 2. As shown, the coating composition of Example 2 exhibited the best performance. The coating composition of Example 2 exhibited the lowest thermal conductivity, followed by the coating composition of Example 3, then the coating composition of Example 1, which exhibited the highest thermal conductivity. Results of the thermal conductivity testing are also shown in Table 5.

TABLE 5
Thermal Conductivity Results

| Coating | Thermal Conductivity |
|---|---|
| Composition | (W/m*K, 50° C.) |
| Example 1 | 0.138 |
| Example 2 | 0.106 |
| Example 3 | 0.124 |

### Coating Skin Temperature

Each of the coating compositions of Examples 1-3 were applied to 100 mm×150 mm×3.175 mm thick steel panels (blasted, 375-100 micron profile, degreased) at a dry film thickness of 5 mm via drawdown. The coated panels were allowed to dry at ambient conditions for 7 days. After which the test panels were heated on a hot plate at the desired test temperatures and the skin temperatures of the coatings were measured with a Peakmeter thermometer using type K thermocouple sensor probe.

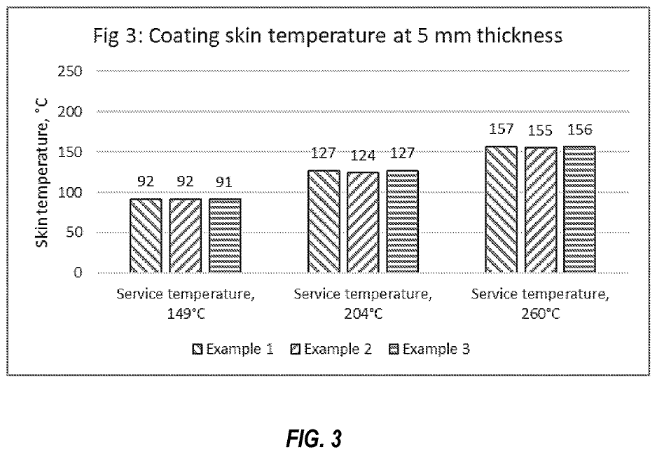

Results of the coating skin temperature testing are shown in FIG. 3. As shown, results are comparable across the tested coating compositions, with the coating composition of Example 2 exhibiting slightly cooler coating skin temperatures at the higher service temperatures tested. Results of the coating skin temperature testing are also shown in Table 6.

TABLE 6
Coating Skin Temperature (° C.) at 5 mm thickness

| Coating | Service temp. | Service temp. | Service temp. |
|---|---|---|---|
| Composition | 149° C. | 204° C. | 260° C. |
| Example 1 | 92 | 127 | 157 |
| Example 2 | 92 | 124 | 155 |
| Example 3 | 91 | 127 | 156 |

### Acoustic Testing

A custom test apparatus is utilized to measure acoustic insertion loss performance using square samples of 13 inches by 13 inches in size. The testing and methodology are in accordance with ISO 9614 and ASTM E2249. Acoustic insertion loss in this application is defined as the difference between sound pressure levels measured on a reference sample and on a specific test sample. A test panel element installed between these two areas, with a high insertion loss value, indicates effective acoustic isolation, and vice-versa.

The test apparatus includes an aluminum, rectangular enclosure with a noise source mounted at one end and a test panel mounted the other end. The noise source is a tube featuring a loudspeaker at one end and an opening at the other end. Noise generated through the loud speaker radiates through the tube and into one end of the rectangular enclosure. The other end of the rectangular enclosure accommodates mounting and dismounting of square test samples of 13 inches by 13 inches length size. The sample edges are acoustically sealed over 1 inch all around the square perimeter, leaving an open area of 12 inches by 12 inches exposed to the noise.

Insertion loss is measured by generating a high, broad band noise within the enclosure, measuring its reference sound pressure levels with a microphone installed inside the enclosure, and comparing it with the sound pressure levels measured outside the enclosure by using a sound intensity probe. Since the external sound intensity probe is traversable in X and Y axis directions, a mapping of the acoustic pressure levels over the center area of the square sample can also be performed. The entire setup is placed within an anechoic room (at room temperature) to minimize influence of other potential acoustic disturbances.

The loudspeaker tube kit generates a random noise up to 25.6 kHz, at constant level. The sound intensity probe includes a pair of microphones positioned 2 inches from the panel, set to a frequency of 50 Hz to 12.5 kHz, ⅓^{rd} octave bands, with averaging time of 16 seconds per point. Measured data includes sound pressure levels (SPL), using units of dB (A) with standard reference pressure of 20 μPa. Reduction in overall sound pressure levels passing through a center sub area of samples can be summed over all ⅓^{rd} octave bands between 125 Hz to 8 kHz. Lower SPL values indicate better noise insulation.

Test panels coated with the insulative silicone coating composition disclosed herein, such as the Example 2 coating composition, are expected to demonstrate a sound insertion loss leading to SPL of 70 to 85 dB(A).

1. An insulative coating composition, comprising:
(a) a room temperature vulcanizing (RTV) polymer comprising
(i) a polysiloxane including hydroxy, acetoxy, epoxy, alkoxy, oxime, and/or amine terminal groups, and/or
(ii) a set of reaction components that react to form the polysiloxane including hydroxy, acetoxy, epoxy, alkoxy, oxime, and/or amine terminal groups;
(b) an adhesion promoter comprising a silane that includes
(i) a polymer crosslinking group comprising an acetoxy, alkoxy, oxime, or amine group, and
(ii) a substrate adhesion group comprising an epoxide, hydroxy, isocyanate, mercapto, phosphonate, or ester group;
(c) an insulating agent; and
(d) a carrier.

2. The coating composition of claim 1, wherein the polysiloxane of the RTV polymer is a dialkyl polysiloxane wherein each alkyl is independently a C1 to C6 alkyl.

3. The coating composition of claim 1, wherein the polysiloxane of the RTV polymer has an average molecular weight of 10,000 to 150,000.

4. The coating composition of claim 1, wherein the RTV polymer is included at a concentration of 3 wt. % to 25 wt. % based on total weight of the coating composition.

5. The coating composition of claim 1, wherein:
the substrate adhesion group of the adhesion promoter comprises a glycidoxy group; and/or
the polymer crosslinking group of the adhesion promoter comprises a methoxy group.

6. The coating composition of claim 1, wherein the adhesion promoter comprises multiple alkoxy groups.

7. The coating composition of claim 1, wherein the adhesion promoter comprises (3-glycidoxypropyl) trimethoxysilane.

8. The coating composition of claim 1, further comprising a moisture scavenger, wherein the moisture scavenger comprises a vinyl group and/or phenyl group.

9. The coating composition of claim 8, wherein the moisture scavenger further comprises an alkoxy group.

10. The coating composition of claim 1, wherein the adhesion promoter is included at a concentration of 0.5 wt. % to 8 wt. %, based on total weight of the coating composition.

11. The coating composition of claim 1, further comprising a tin-based catalyst and/or titanate-based catalyst.

12. The coating composition of claim 11, wherein the tin-based catalyst comprises:
(i) an alkyl group; and/or
(ii) an acetoxy group.

13. The coating composition of claim 1, wherein the insulating agent comprises hollow microspheres comprising glass, borosilicate, aluminum silicate, ceramic, and/or polymer material.

14. The coating composition of claim 1, wherein the carrier comprises a ketone, alcohol, aliphatic hydrocarbon, aromatic hydrocarbon, ester, ether, and/or halogenated hydrocarbon.

15. The coating composition of claim 1, wherein the coating composition comprises a two part system, wherein the RTV polymer and/or the adhesion promoter are included in a first part of the two part system and a catalyst is included in a second part of the two part system.

16. The coating composition of claim 1, wherein the RTV polymer is dissolved in the carrier or wherein the RTV polymer is suspended in the carrier.

17. The coating composition of claim 1, wherein the coating composition is essentially free or completely free of polysiloxane resins apart from the RTV polymer.

18. The coating composition of claim 1, wherein the coating composition, when cured, exhibits:
a pull-off adhesion strength of 50 psi or greater after room temperature cure, according to ASTM D4541-22;
a pull-off adhesion strength of 50 psi up to 400 psi, after 260° C. exposure for 100 hours, according to ASTM D4541-22; and/or
a thermal conductivity of 0.12 W/m*K or less according to ASTM 7984-16 measured at 50° C.

19. (canceled)

20. A substrate coated at least in part with the coating composition of claim 1.

21. (canceled)

22. The coating composition of claim 5, wherein the substrate adhesion group of the adhesion promoter comprises a glycidoxyalkyl group.
